(19) United States
(12) Patent Application Publication
(10) Pub. No.: US 2026/0054504 A1
(43) Pub. Date: Feb. 26, 2026

(54) Portable Handheld Self-Adhesive Tape Applicator and Printer

(71) Applicant: B.V. Korthofah, Katwijk (NL)

(72) Inventor: Meindert de Groot, Katwijk (NL)

(21) Appl. No.: 19/279,523

(22) Filed: Jul. 24, 2025

(30) Foreign Application Priority Data
Aug. 26, 2024 (NL) 2038494

(51) Int. Cl. B41J 3/407; B41J 2/325; B41J 11/70; B41J 15/02; B41J 15/04; B41J 25/304; B41J 29/393; B41J 31/14; B41J 32/00; B41J 35/08; B65C 11/02

(52) U.S. Cl. CPC B41J 3/4075; B41J 2/325; B41J 11/703; B41J 15/02; B41J 15/04; B41J 25/304; B41J 29/393; B41J 31/14; B41J 32/00; B41J 35/08; B65C 11/0284; B65C 2201/00; B65C 2210/0045; B65C 2210/0054; B65C 2210/007

(57) ABSTRACT

A thermal transfer printer incorporated into a portable handheld applicator for self-adhesive tape (also known as a tape gun), allowing to print variable data in real-time on the backside of the tape before it is manually applied onto packaging and/or products. Variable logistical and/or traceability information can be printed directly onto any off-the-shelf self-adhesive tape so that an additional adhesive label on the product and/or packaging will no longer be required. It also allows for a reduction in the amount of preprinted tape and/or packaging material. All needed visual differentiations (branding, product information, packaging content or other) can be displayed on the tape while keeping the packaging itself standardized.

### CROSS-REFERENCE TO RELATED APPLICATIONS

This application claims priority to and the benefit of Netherlands Patent Application No. 2038494, entitled “PORTABLE HANDHELD SELF-ADHESIVE TAPE APPLICATOR AND PRINTER”, filed Aug. 26, 2024, and the specifications and claims thereof are incorporated herein by reference.

### BACKGROUND OF THE INVENTION

### Field of the Invention

Embodiments of the invention relate to the field of adhesive tape applicators and label printers, and more particularly to a portable handheld self-adhesive tape applicator.

### Background

Handheld self-adhesive tape applicators are widely used in various industries from manufacturing to logistics. Nowadays, sealing and labeling a package is a two steps process. CN207107054U proposed a handheld self-adhesive tape applicator equipped with a label printer to make sealing and labeling the package a one-step process. However, CN207107054U discloses a direct thermal printer which cannot be used in combination with an off-the-shelf self-adhesive tape because it requires the self-adhesive medium to comprise a thermally sensitive layer. Additionally, it requires an electric motor that drives the paper roll on which the label is printed, which increases the weight and costs of the device and reduces its reliability. If the electrical motor breaks, the device of CN207107054U cannot be used anymore.

### BRIEF SUMMARY OF THE INVENTION

It is an object of the invention to correct the short-comings of the prior art and to propose an alternative solution for sealing and labeling in a one-step process.

This and other objects which will become apparent from the following disclosure, are provided with a portable handheld self-adhesive tape applicator having the features of one or more of the appended claims.

Embodiments of the present invention incorporate a thermal transfer printer into a portable handheld applicator for self-adhesive tape (also known as a tape gun) which is arranged to be used in combination with standard off-the-shelf self-adhesive tape without thermal reactive coating. This enables to print variable data in real-time on the backside of the self-adhesive tape without thermal reactive coating while it is manually applied onto packaging and/or products. One benefit of this is that variable logistical and/or traceability information can be printed directly onto the tape so that an additional adhesive label on the product and/or packaging will no longer be required.

Embodiments of the invention also allow for a reduction in the amount of preprinted tape and/or packaging material. Visual differentiations (branding, product information, packaging content or other) can be displayed on the tape while keeping the packaging itself standardized.

In one embodiment of the invention, a portable handheld self-adhesive tape applicator includes:
a first roller for unwinding a roll of self-adhesive tape; and
a second roller for applying the self-adhesive tape onto a substrate when the portable handheld applicator is pressed and rolled against said substrate,
wherein the portable handheld applicator is arranged to transfer the self-adhesive tape from the first roller to the second roller, said tape applicator further comprising a printer, wherein the first roller is loaded with a standard off-the-shelf self-adhesive tape, and the printer is a thermal transfer printer for printing on a non-adhesive side of the self-adhesive tape.

Preferably the thermal transfer printer comprises:
a third roller and a fourth roller, wherein the third roller and/or the fourth roller are/is mechanically driven by the first roller; and
said thermal transfer printer is arranged to receive a printing ribbon that runs between the third roller and the fourth roller, wherein the third roller is configured for unwinding and feeding unused printing ribbon, and the fourth roller is configured for winding and recuperating used printing ribbon.

Using a thermal transfer printer enables the use of any off-the-shelf tape. Since the printer is mechanically driven by the movement of the tape roll of the tape applicator, there is no need for an electrical engine.

Advantageously, the printer may also include a printing head movable between a printing position and a stand-by position, preferably on top of a stretched part of the printing ribbon.

More advantageously, the printing head is preferably configured to press the printing ribbon against the non-adhesive side of the self-adhesive tape when said printing head is in printing position.

As used herein, the “printing position” is when the printing head is pressing the printing ribbon against the self-adhesive tape, unless otherwise described. The “stand-by position” is when the printing head is retracted inside the printer letting the self-adhesive tape roll freely, unless otherwise described.

To prevent jamming and wrinkling of the self-adhesive tape, the first roller comprises a one-way clutch allowing said first roller to rotate exclusively in a rotational direction for unwinding the roll of self-adhesive tape.

Suitably, the second roller comprises a one-way clutch allowing said second roller to exclusively rotate in a rotational direction which serves during use for guiding the self-adhesive tape onto the substrate, and which direction is preferably opposite to a rotational direction of the first roller. A user presses the second roller onto the substrate and moves the portable handheld applicator to apply the self-adhesive tape. The movement of the portable handheld applicator rotates the second roller, which rotates the first roller via the self-adhesive tape.

To prevent jamming and wrinkling of the printing ribbon, the fourth roller comprises a one-way clutch allowing said fourth roller to rotate exclusively in a rotational direction for winding the used printing ribbon.

Advantageously, the portable handheld applicator may also comprise a trigger for controlling the printer.

More advantageously, the trigger is preferably mechanically connected to the printing head, usually but not necessarily through a system of arms and clutches, wherein the printing head is configured to move into printing position when the trigger is pulled, and wherein the printing head is configured to retract into stand-by position when the trigger is released.

Preferably the system of gears and clutches mechanically connecting the third roller and/or the fourth roller to the first roller may be engaged when the trigger is pulled and are disengaged when the trigger is released.

Optionally, the portable handheld applicator comprises at least one sensor for measuring a rotational speed of the first roller.

The printing head may be activated when the rotational speed of the first roller is nonzero.

Suitably, a printing speed of the printing head is proportional to the rotational speed of the first roller. This results in compensating for any possible fluctuations in the rotating speed of the tape roll that could otherwise stretch or compress the print.

The printing head is mechanically connected to a compression system for maintaining pressure on the printing ribbon when said printing head is in printing position. To keep the printing head pressure on the tape as constant as possible a compression mechanism (spring, air cylinder or other) is used. This not only compensates for the print position moving further away as the tape roll diameter decreases, but also absorbs abrupt actuations of the trigger, or shocks in the system. Once the trigger is released the printing head will move away from the substrate and back again to its stand-by position, allowing the tape roll to rotate freely as contact is no longer made.

The third roller and the fourth roller may be embodied inside a disposable printing cartridge. This cartridge may be side loaded over the printing head so that each one of the third and the fourth rollers is positioned on either side of the printing head while the printing ribbon in between these two rollers runs underneath it. When the printing head is actuated downwards, it pushes the printing ribbon against the self-adhesive tape roll in order to print. Once the printing ribbon is depleted printing is no longer possible. In this case all the ribbon will be used and wound on the fourth roller, while the third roller will be empty. In order to continue printing a new cartridge with a full feed spool may be inserted. The user may visually verify how much ribbon is left on the feed spool through a see-through section in the cartridge.

Suitably, the third roller and/or the fourth roller are/is manually rotatable via a rotation knob on an outer side of the printing cartridge.

The third roller is connected to a mechanical break for tensioning the printing ribbon.

The self-adhesive tape may comprise a plastic material and/or a composition with a paper material. Fabric materials may also be used.

The portable handheld applicator may comprise a handle for holding the applicator. Equal to a traditional tape gun the system is also operated manually with a handle. Using the handle the user presses the portable handheld applicator onto the substrate and pulls it downwards. This unwinds the tape from the roll as it's being applied.

The portable handheld applicator may comprise a power source such as a battery. The battery may be slidable in the handle, and removable. It may also be rechargeable.

An outer casing of the portable handheld applicator may comprise a cutting device, such as a knife. Once the desired amount of tape is applied onto the substrate the cutting device is used to cut the strip of tape. The cutting device is engaged by tilting the system while simultaneously pressing it towards the substrate with the handle.

An outer casing of the portable handheld applicator comprises a flexible plate protruding from said outer casing. After cutting the tape the last bit of tape strip is applied onto the substrate with a flexible plate. This plate presses the tape onto the substrate by further tilting the system while simultaneously pressing it towards the substrate with the handle.

Suitably, the portable handheld applicator may comprise a wireless and/or a wired communication system for receiving data to be printed. Additionally, the portable handheld applicator may comprise a digital memory for storing data to be printed. This enables seamlessly receiving real-life data to be printed on the tape.

Advantageously the portable handheld applicator is connectable or comprises a voice input system, in particular a microphone, and a processor for converting spoken information into text in a format suitable to be printed. In this way the user may avoid the tedious task of having to type out the required text to be printed, but will it suffice to simply speak the information that is required on the label which will be printed out. This saves a lot of time.

Suitable embodiments may include an analog-to-digital converter for converting speech into data to be printed. This is however not essential. It may also be possible although not required to include an artificial neural network which is trained for automatic speech recognition.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a schematic illustration showing a side view of an apparatus according to an embodiment of the present invention.

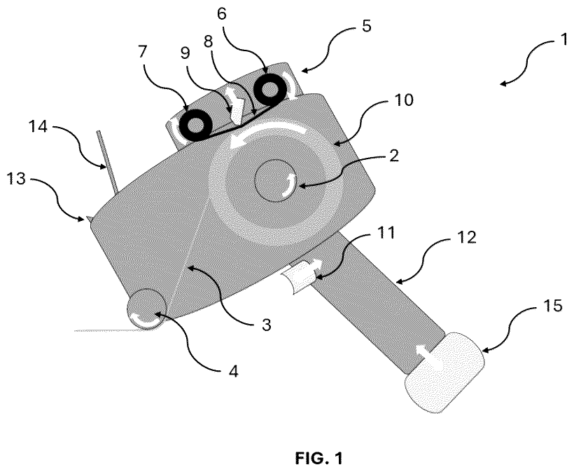

### DETAILED DESCRIPTION OF THE INVENTION

Embodiments of the present invention are directed to portable handheld applicator 1. A thermal printhead may be advantageously located slightly above the print position, which is on the outside of self-adhesive tape roll 10, while also positioned in between third roller 6 and fourth roller 7 with thermal printing ribbon 8. Third roller 6 located before the print position is the feed roller on which new unused printing ribbon is reeled. Fourth roller 7 located after the print position is the uptake roller that collects ribbon 8 after it's being used. This causes the trajectory of the printing ribbon to run in between the two rollers 6, 7 underneath printhead 9 and over substrate/tape roll 10.

By engaging/pressing trigger 11 on handle 12 of portable handheld applicator 1, a series of mechanisms are set in motion that together perform a print cycle.

Firstly, the physical movement of trigger 11 is preferably mechanically transferred to printing head 9 in order to actuate itself, and printing ribbon 8 running underneath it, against the print position on the non-adhesive side of self-adhesive tape 3. Subsequently the trigger may also mechanically engage a clutch that connects the axis of fourth roller 7 to the axis of first roller 2.

When tape roll 10 is unwound (as would happen when it is applied onto a substrate) through the clutch fourth roller 7 shall also rotate. And thus transport printing ribbon 8 through the print position under printing head 9 while printing head 9 is pressing it against roll 10 of tape 3 which is rotating at the same, or at almost the same, speed.

Subsequently the thermal dot line of printing head 9 shall be activated. This will produce a print by melting coloring agent from moving printing ribbon 8 onto the outside of rotating self-adhesive tape roll 10 as it passes underneath printing head 9.

The printing speed of the printing head is preferably proportional to the rotational speed of the first roller. This results in compensating any possible fluctuations in the rotating speed of the tape roll that could otherwise stretch or compress the print.

When the print cycle is completed, trigger 11 may be released/disengaged. Once the trigger is disengaged, printing head 9 and printing ribbon 8 will move back to their stand-by position inside the printer allowing tape roll 10 to rotate freely. Simultaneously the third and fourth rollers 6, 7 shall also become static as the clutch between the axis of fourth roller 7 and the axis of first roller 2 will also disengage upon releasing trigger 11. Meaning that with trigger 11 disengaged, the system will apply tape without prints.

By timing the engagement of trigger 11, the user can print on any desired position(s) of the tape strip as he applies it on the substrate. Print content can be digitally pre-loaded into the system memory, or directly sent to the memory system via wireless or wired communication, which then is rendered into an image in real-time as the tape in being applied. This allow the prints to contain real-time digitally generated variable data. Including dynamic barcodes, self-updating (date) counters and more.

Embodiments of the present invention can include every combination of features that are disclosed herein independently from each other. Although the invention has been discussed in the foregoing with reference to an exemplary embodiment of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Note that in the specification and claims, “about” or “approximately” means within twenty percent (20%) of the numerical amount cited. The terms, “a”, “an”, “the”, and “said” mean “one or more” unless context explicitly dictates otherwise.

Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

What is claimed is:

1. A portable handheld self-adhesive tape applicator comprising:
a first roller for unwinding a roll of self-adhesive tape;
a second roller for applying the self-adhesive tape onto a substrate when the applicator is pressed and rolled against said substrate,
wherein the applicator is arranged to transfer the self-adhesive tape from the first roller to the second roller, said tape applicator further comprising a printer, and wherein the first roller is loaded with standard off-the-shelf self-adhesive tape without thermal reactive coating, and the printer is a thermal transfer printer for printing on a non-adhesive side of the self-adhesive tape.

2. The portable handheld self-adhesive tape applicator according to claim 1, wherein the thermal transfer printer comprises:
a third roller and a fourth roller, wherein the third roller and/or the fourth roller are/is mechanically driven by the first roller; and
said thermal transfer printer is arranged to receive a printing ribbon that runs between the third roller and the fourth roller, wherein the third roller is configured for unwinding and feeding unused printing ribbon, and the fourth roller is configured for winding and recuperating used printing ribbon.

3. The portable handheld self-adhesive tape applicator according to claim 1, wherein the thermal transfer printer comprises a printing head movable between a printing position and a stand-by position.

4. The portable handheld self-adhesive tape applicator according to claim 3, wherein the printing head is configured to press the printing ribbon against the non-adhesive side of the self-adhesive tape when said printing head is in printing position.

5. The portable handheld self-adhesive tape applicator according to claim 1, wherein the first roller comprises a one-way clutch allowing said first roller to rotate exclusively in a first rotational direction for unwinding the roll of self-adhesive tape.

6. The portable handheld self-adhesive tape applicator according to claim 1, wherein the second roller comprises a one-way clutch allowing said second roller to exclusively rotate in a second rotational direction during use for guiding the self-adhesive tape onto the substrate.

7. The portable handheld self-adhesive tape applicator according to claim 2, wherein the fourth roller comprises a one-way clutch allowing said fourth roller to rotate exclusively in a rotational direction for winding the used printing ribbon.

8. The portable handheld self-adhesive tape applicator according to claim 1, wherein the applicator comprises a trigger for controlling the thermal transfer printer.

9. The portable handheld self-adhesive tape applicator according to claim 3, wherein the trigger is mechanically connected to the printing head, wherein the printing head is configured to move into printing position when the trigger is pulled, and wherein the printing head is configured to retract into stand-by position when the trigger is released.

10. The portable handheld self-adhesive tape applicator according to claim 2, wherein the third roller and/or the fourth roller are engaged to the first roller when the trigger is pulled and are disengaged when the trigger is released.

11. The portable handheld self-adhesive tape applicator according to claim 1, wherein the applicator comprises at least one sensor for measuring a rotational speed of the first roller.

12. The portable handheld self-adhesive tape applicator according to claim 3, wherein the printing head is activated when the rotational speed of the first roller is nonzero.

13. The portable handheld self-adhesive tape applicator according to claim 3, wherein during operation a printing speed of the printing head is proportional to the rotational speed of the first roller.

14. The portable handheld self-adhesive tape applicator according to claim 3, wherein the printing head is mechanically connected to a compression system for maintaining pressure on the printing ribbon when said printing head is in printing position.

15. The portable handheld self-adhesive tape applicator according to claim 2, wherein the third roller and the fourth roller are embodied inside a removable and disposable printing cartridge.

16. The portable handheld self-adhesive tape applicator according to claim 15, wherein the third roller and/or the fourth roller are/is manually rotatable via a rotation knob on an outer side of the printing cartridge.

17. The portable handheld self-adhesive tape applicator according to claim 2, wherein the third roller is connected to a mechanical break for tensioning the printing ribbon.

18. The portable handheld self-adhesive tape applicator according to claim 1, wherein the self-adhesive tape comprises a plastic material and/or a paper material.

19. The portable handheld self-adhesive tape applicator according to claim 1, wherein the applicator comprises a handle for holding the applicator.

20. The portable handheld self-adhesive tape applicator according to claim 1, wherein the applicator comprises an electrical power source.

21. The portable handheld self-adhesive tape applicator according to claim 1, wherein an outer casing of the applicator comprises a cutting device.

22. The portable handheld self-adhesive tape applicator according to claim 1, wherein the outer casing of the applicator comprises a flexible plate protruding from said outer casing.

23. The portable handheld self-adhesive tape applicator according to claim 1, wherein the applicator comprises a wireless and/or a wired communication system for receiving data to be printed.

24. The portable handheld self-adhesive tape applicator according to claim 1, wherein the applicator comprises a digital memory for storing data to be printed.

25. The portable handheld self-adhesive tape applicator according to claim 1, wherein the applicator is connectable or comprises a voice input system and processor for converting spoken information into text in a format suitable to be printed.
